(19) United States
(12) Patent Application Publication
(10) Pub. No.: US 2022/0119128 A1
(43) Pub. Date: Apr. 21, 2022

(54) SYSTEM AND METHOD TO ASSESS AND REPORT RUNWAY CONDITIONS

(71) Applicant: Hydro-Aire, Inc., a subsidiary of Crane Co., Burbank, CA (US)

(72) Inventors: Ronald Raby, Chatsworth, CA (US); Leo Pashaian, Glendale, CA (US); Ilan Paz, Tarzana, CA (US)

(73) Assignee: Hydro-Aire, Inc., a subsidiary of Crane Co., Burbank, CA (US)

(21) Appl. No.: 17/499,585

(22) Filed: Oct. 12, 2021

Related U.S. Application Data
(60) Provisional application No. 63/093,622, filed on Oct. 19, 2020.

(51) Int. Cl. B64D 45/04; B64C 25/46; H04L 12/40

(52) U.S. Cl. CPC B64D 45/04; B64C 25/46; H04L 2012/40215; H04L 2012/4028; H04L 12/40

(57) ABSTRACT

The present invention is a system and method for evaluating runway conditions that combines known brake control systems with a new runway condition monitoring unit working in conjunction with an anti-skid/brake control unit to improve runway condition evaluation. The runway condition monitoring unit is installed on an airplane and receives data from the brake control unit, and processes that data through hardware and software to formulate a runway condition report of the airplane while landing on a runway. The invention may include additional sensors or interfaces that supplement the data received from the BCU. The runway condition monitoring unit contains a processor and interfaces that calculates and creates a runway condition report. The runway condition monitoring unit communicates the report by way of the avionics communication network on the airplane to devices that then send the runway condition report to consumers of the data, such as the flight deck, air traffic controllers, airport operators and airline operations.

### CROSS-REFERENCES TO RELATED APPLICATIONS

This application claims priority to U.S. Application No. 63/093,622, filed Oct. 19, 2020, the content of which is fully incorporated herein by reference.

### BACKGROUND

While aircraft travel is considered among the safest modes of transportation, there are elements of air travel that remain a challenge. One of the most critical aspects of travel by aircraft is the landing, and more particularly, landing in inclement weather. Each year there are numerous cases of commercial aircraft landing or taxiing in poor weather conditions on runways affected by adverse runway conditions that result in problems with the landing or control of the aircraft. A major contributor to these events is a difficulty for the pilot to establish enough braking friction on wet or frozen wheels/runways to safely bring the aircraft to a controlled stop. This can lead to overrunning of the runway or other hazardous situations that are perilous for the aircraft and/or the passengers.

One present method for evaluating unfavorable runway conditions relates to subjective pilot evaluations of the runway conditions that are communicated to the airport tower personnel and then relayed to subsequent aircraft. These evaluations rely on the pilot's subjective feel and feedback from the aircraft after landing on the runway itself. Repeated reports gathered by the controllers in the tower are used to make a general assessment of the landing risks for subsequent aircraft. Since these evaluations are primarily subjective and based on pilot evaluation, these subjective criteria often vary from pilot to pilot and can be unreliable for various reasons, including whether a pilot is not willing to admit that a landing was challenging or risky.

There is a need in the art for a more objective determination of the landing conditions on a runway at a particular location in inclement weather. While there are various methods in place that attempt to determine and communicate runway temperatures, moisture, humidity, etc., the present invention uses data from the aircraft brake control/anti-skid system (hereafter referred to as the brake control system (BCS)) to determine a developed real-time braking effectiveness. The brake control system acquires raw data from the airplane on board brake control system sensors, and this information can be used and combined with separate sensors and data to generate a runway report. Namely, GPS and accelerometer information can be combined with the elemental data calculated from brake control system algorithms to this data is utilized to produce an objective runway condition report. This report, based on real time braking conditions, is through various means then communicated to the flight deck and/or to on-board monitoring systems which forward the report information to air traffic controllers, airport operators, airline operational centers, and subsequently to flight crews on approaching flights landing on the same runway.

Moreover, current aircraft braking system do not typically rely on or use GPS data in the assessment of a runway. However, there are some braking systems on commercial airplanes that that use navigational latitude and longitude to predict the “end of runway approaching” and perform autobraking functions in relation to “brake to exit” or “brake to vacate” features of the braking system. More often these systems rely on data that is provided by the aircraft's air data that is faster and use more precise navigation and inertial reference systems rather than GPS units that update slower (e.g. on the order of once per second). In relation to runway conditions there are currently two accepted standards: a pilot report that describes a qualitative report of the overall braking action for the complete landing stop, and; a runway condition assessments of the airport operator that describes the runway condition in terms of condition, contaminants and position on the runway (divided into thirds).

Having position as a function of GPS or an airplane's navigation system adds precision to a runway condition report generated by the present invention and thus improves the accuracy of the report. That is, a runway report with GPS coordinates is beneficial to airport operators to find poor or deteriorating areas on the runway that could use immediate attention. When used correctly, the system of the present invention allows for an assessment of the repairs as it relates to other areas of the runway.

### SUMMARY OF THE INVENTION

The present invention is a system and method to assess and report runway conditions that operates in conjunction with real time data acquired and calculated by the aircraft's antiskid/brake control system. The system and method collects and processes real time data acquired within the brake control unit from brake control sensors, airplane-acquired data and data processed through the brake control laws to generate and produce, through a series of algorithms, a report of runway conditions.

The system of the present invention may be installed on an aircraft to process data from the brake control system and to formulate a runway condition report of the aircraft as it lands on a given runway. This runway condition report is based on data collected during the landing process, and comprises a quantitative assessment of the landing from the time of touchdown to either a low speed threshold or when the airplane comes to a complete stop.

In one embodiment of the system and method, the essential algorithms are hosted entirely in the antiskid/brake control unit hardware. In another embodiment, the system comprises an antiskid/brake control unit and a separate runway condition monitoring unit. The system may also include additional sensors or interfaces that supplement the data received from the brake control unit such as a Global Positioning System (GPS) receiver and stand-alone accelerometers to provide instantaneous calculations and report based on position on the runway in addition to a report for the complete landing. Having an instantaneous condition based on position and location on the runway is extremely useful to airport operations to identify specific locations needing attention. Having an internal accelerometer allows for instantaneous deceleration calculations and more accurate calculations.

For every landing, the system assesses runway conditions and then calculates and creates a runway condition report. The report is communicated by way of a communication network on the aircraft to devices that then send the runway condition report to consumers, either to the pilots in the flight deck by means of the airplane's communication data bus or to consumers of runway condition data such as airline operators or airport operations by means of communication to other onboard systems, or through wireless communication.

### BRIEF DESCRIPTION OF THE DRAWINGS

FIG. 1 is a schematic diagram of an exemplary commercial aircraft illustrating the arrangement of the elements of the system of the present invention in the environment of the aircraft;

FIG. 2 is a schematic diagram showing potential inputs to the present invention;

FIG. 3 is a flow chart of the runway report path of the present invention;

FIG. 4 is a schematic of the runway condition monitoring unit;

FIG. 5 is a flow chart of the data input and output of the present invention; and

FIG. 6 is a runway condition report flow chart.

### DETAILED DESCRIPTION OF THE PREFERRED EMBODIMENTS

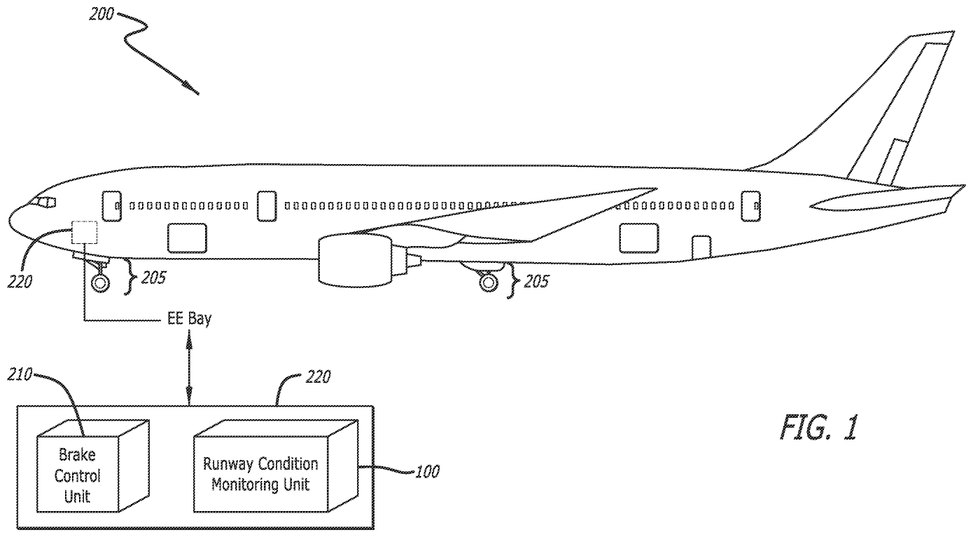

FIG. 1 illustrates a commercial aircraft 200 with a conventional landing gear 205 that is connected to and controlled by a brake control unit 210 in the aircraft electronics bay 220. The brake control unit 210 receives signals from the various sensors at the landing gear 205. Heretofore, brake control unit was responsible for the assessment of the runway conditions and for transmitting the assessment. The present invention relieves the brake control unit of this function, since often times the brake control unit communication interface is not open to the necessary aircraft devices needed to communicate the runway condition report to locations outside the aircraft. This is because there are insufficient data interfaces to produce an instantaneous runway report based on a position of the runway. While the prior art runway data could be sent to the pilot, the present invention can send generated reports to airlines, airport traffic control, and airport operations. To accomplish the goals of the present invention, a new hardware component is introduced in the form of a runway condition monitoring unit 100 that receives data and receive data from the brake control unit 210, and generates a report that is disseminated to various clients.

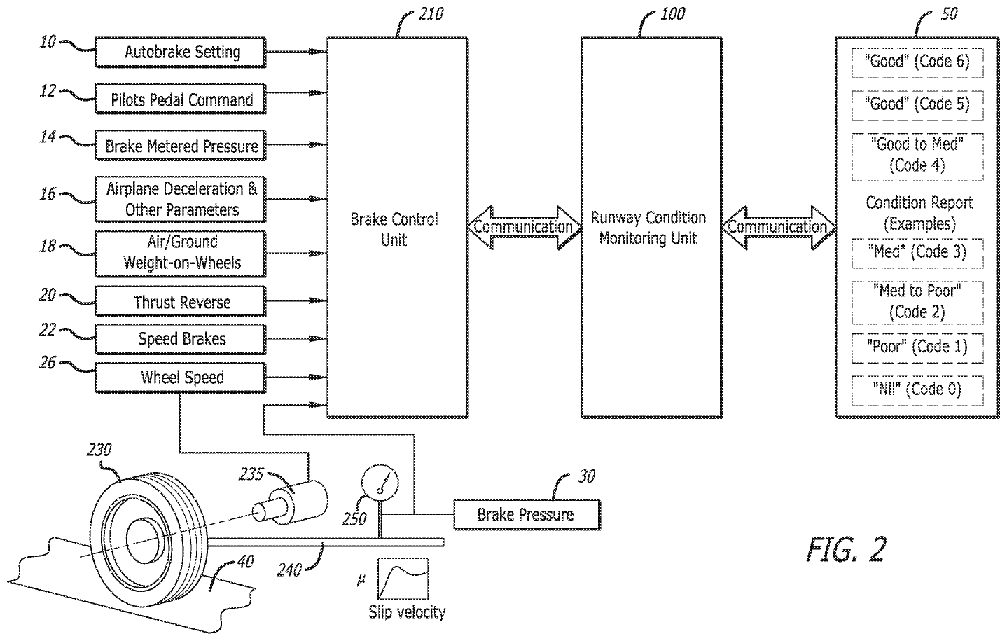

FIG. 2 illustrates a schematic diagram of some of the various inputs that are utilized by the system and method of the present invention to generate a report that objectively assesses a landing condition in the present invention. It should be noted that in FIG. 2, the runway condition monitoring unit 100 is shown as a separate component from the brake control unit 24, however in other embodiments of the invention the two components can be merged into a single unit. Runway data is collected and processed by the brake control unit. This data is a collection of data from sensors that are installed on an airplane and are part of the brake control system. Runway condition data is also data acquired from the results of the aircraft's antiskid/brake control algorithms that are also relevant in the determination of the runway condition. The present invention use the runway monitoring unit to calculate and pass directly the brake control unit's assessment to other systems on the aircraft, or the present invention may process data from the brake control unit 24 through its own runway condition determination algorithms in the runway condition monitoring unit 100 to create a new runway condition report. It should be noted that it is advantageous and unique for the runway condition to be determined from data acquired and calculated from the brake control unit 24.

The aircraft 200 has multiple landing gear wheels 230 which are mounted on its axle 235, which supports a brake line 240. A sensor 250 measures the brake pressure applied to the wheel, and this measured data is communicated to the brake control unit 210. Other inputs to the brake control unit 210 include the following:

the autobrake setting 10 from the cockpit

the pilot's pedal commands 12 from the cockpit

the brake metered pressure 14 from a sensor

the aircraft deceleration and aircraft position 16

the inertial reference system ground speed

the weight on wheels 18

thrust reverse value 20

the spoiler/speedbrake deployment 22.

Each of these inputs are fed to the brake control unit 24, along with the actual wheel speed 26 taken at the axle wheel speed transducer, and the brake pressure 30 using a pressure transducer at the wheel 230. Each of these factors are used to evaluate an objective braking quality factor of the tire-runway interface 40.

The brake control unit determines a runway/aircraft interface status and sends the data to the runway condition monitoring unit 100. The runway condition monitoring unit 100 can then incorporate additional inputs, such as a stand-alone accelerometer module and/or a Global Positioning System (GPS) module as additional data source for processing, calculating and displaying the runway condition. The runway condition monitoring unit 100 includes a processor that collects, processes, and stores data using a computer program, where input from each wheel 230 in the landing gear 205 is fed to the program. The program performs numerous calculations according to specific algorithms, and outputs a unique and objective runway condition report that may be stored, broadcasted, and otherwise made available through various means to subsequently landing aircraft at the same runway.

In some embodiments, the processor of the runway condition monitoring unit 100 receives all of the data and undertakes a data processing program which incorporates: (a) wheel speed (b) wheel spin-up time (c) time on ground (d) wheel deceleration (e) aircraft ground speed (f) aircraft deceleration (g) wheel speed spin-up recovery (h) hydroplaning condition (i) autobrake commanded pressure (j) autobrake deceleration error (k) anti-skid wheel slip error (l) anti-skid velocity reference (m) anti-skid PBM/Integral Command (n) braking command; and (o) wheel slip velocity. Each of these various factors are analyzed to arrive at a braking quality factor of the runway condition determination, which may quantifiable (e.g., 8.8/10) or qualitative (e.g., “GOOD,” “GOOD TO MEDIUM,” “MEDIUM,”, “MEDIUM TO POOR” “POOR”, “NIL”, etc.). In some instances, braking may be insufficient to create an objective report, for example when a pilot has employed lightly applied pedals or when low autobrake settings are used. In such cases, “INSUFFICIENT BRAKING or NO COMPUTED REPORT” might be generated. The ultimate condition is compiled in a condition report 50, which may be made available to subsequent pilots landing on the same runway, as well as kept for future analysis. In this way, a more objective approach to runway landing conditions is available to the pilots. The scale of the reports can be tailored based on the needs of a user community or the specific reporting system. It is possible that in the future an industry or regulatory agency adopts standard terms for describing tire/runway friction, and the present invention would incorporate those terms for reporting to the aircraft information system.

One advantage of the described embodiment is that all of the data used to determine the braking condition can be taken from the aircraft's brake control system. The determination of the runway condition can be used with either autobraking or pedal braking, where each option uses a separate branch to evaluate the braking surface. In one embodiment, the runway condition is determined during the landing roll, such as immediately after landing when the wheels spin up, and throughout various phases during the deceleration of the aircraft (e.g., at 100 kts groundspeed, 75 kts, 50 kts, etc.) or its specific position on the runway. The determination of the braking conditions evaluates whether autobrake or maximum brake pressure is employed, partial brake pressure employed, and if any hydroplaning is occurring. In a preferred embodiment, all of the wheels in the landing gear are evaluated using the techniques referenced herein to better evaluate the conditions on the runway surface.

A discussion of the brake control unit (“BCU”) is described in U.S. Pat. No. 9,701,401, the content of which is incorporated herein by reference in its entirety, and a full description is not repeated here for brevity. The role of the runway condition monitoring unit 100 is to evaluate readings from various landing gear data and instruments to make an evaluation of the available tire/runway friction conditions for a particular runway that is not subjective to the pilot but rather objectively determined. Both input from the BCU and other factors may be added to the calculus to arrive at more quantitative scores. Moreover, because the factors that go into the reporting are not subjective, pilots will gain further confidence and understanding of the various terms such as “GOOD” or “MODERATE” since they will be consistent each time the pilot lands. In this way, the present invention is a significant improvement over other systems for determining landing conditions on an aircraft runway.

The runway condition monitoring unit 100 may also consider the rate of wheel spin-up (wheel acceleration) for each wheel when in landing mode, at initial aircraft touchdown, as an initial indication of runway friction and runway condition. This data can be incorporated into the final evaluation of the landing conditions as well. The unit may also use data from the Brake Control Antiskid System's autobrake function when it is the method chosen over manual braking, or use autobrake commanded pressure and deceleration setting as criteria for determining runway condition.

Additional embodiments of the present embodiment can use data from the Brake Control Antiskid System when manual braking is applied by the pilot or first officer, and where the system distinguishes if antiskid activity is present or not. When braking is insufficient to produce antiskid activity, the runway condition monitoring unit 100 may use aircraft generated deceleration reference or brake control system (wheel speed) generated deceleration, or brake control system internal sensors to determine whether sufficient braking deceleration is achieved. Alternatively, when braking is sufficient to produce antiskid activity, the system may use antiskid brake control command integrator/pressure bias modulation (PBM) and/or brake pressure feedback to determine if braking activity is in a low pressure region.

Other factors may also influence the determination of the landing conditions. For example, when braking is sufficient to produce antiskid activity the system may use antiskid brake control determined wheel slip velocity and wheel slip error as an indication of runway condition, or the program may use the rate of wheel spin-up (wheel acceleration) during skid recovery as an indicator of runway condition. The program could also use an antiskid/brake control command and aircraft deceleration as criteria for determining runway condition. A comparison can be made as to the aircraft deceleration with wheel speed to determine if individual wheel hydroplaning conditions exist. The system then uses a hydroplane condition as a criterion for determining the braking quality factor. Other factors that may be incorporated into the program include inputs such as landing speed, brake pedal position or pilots metered brake pressure and ground spoiler handle position and thrust lever actuation as additional criteria for determining runway condition. The system may also conduct an initial evaluation and reporting of condition upon touchdown, as well as periodic evaluation and reporting of condition throughout the landing roll. Additionally, the program may compare its inputs with time phased profiles representative of the landing conditions to dynamically determine runway condition throughout the landing roll, and evaluate information from each main landing gear wheel channel to establish the overall runway condition being reported.

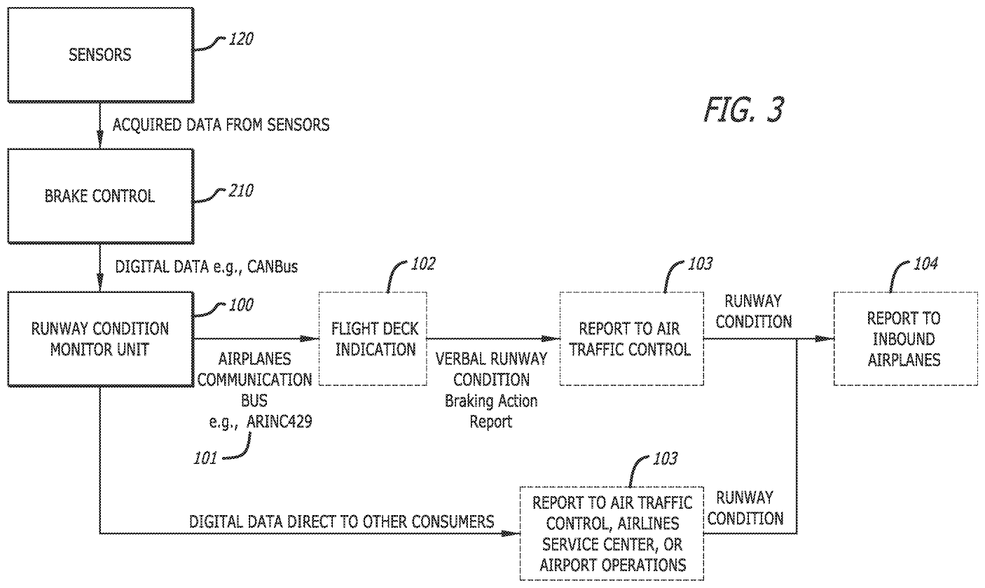

FIG. 3 is a schematic of interrelationship between the braking system and runway condition monitoring unit, and the potential recipients of the runway condition report. The sensors 120 in the aircraft, such as wheel speed sensor, braking pressure transducer, etc., are received in the BCU 210 as described with respect to FIG. 2. The BCU 210 communicates directly with the runway condition monitoring unit 100, which utilizes the input from the BCU (and possibly other sensors that report directly to the runway condition monitoring unit), and the software within the BCU analyzes the input and generates a quantitative runway condition report. The runway condition monitoring unit 100 is equipped with a communications system that allows the runway condition monitor unit to transmit the report via the aircraft communication bus 101 to the flight deck 102.

Additionally, the report can be sent directly from the runway condition monitor unit 100 (via other onboard aircraft systems) to the air traffic control, airlines, and/or airport operations. When the pilots of the landing aircraft receive the report on the flight deck 102, they can add a subjective evaluation of the conditions on the runway, and these subjective evaluations are forwarded orally to the air traffic control 103 along with the generated report. The runway conditions report 50, along with the pilot's subjective evaluation, can then be transmitted by the air traffic control tower to subsequent flights 104 so that both a history and an accumulation of reports is developed for each runway on each day. The combination of an objective report and a subjective evaluation by the pilot is the safest approach to guiding subsequent flights on potentially hazardous or difficult runway conditions.

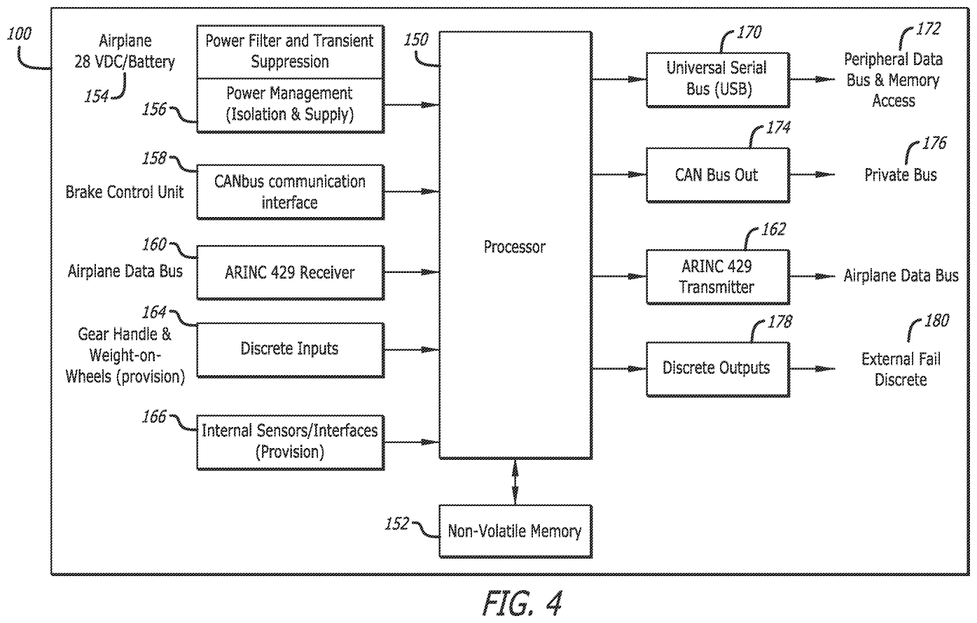

FIG. 4 shows a schematic diagram of the runway condition monitoring unit 100 and its components. The central element of the runway condition monitoring unit is the processor 150 that carries out the calculations and employs the algorithms to generate the modified runway condition report. The processor 150 is preferably a high-performance microcontroller containing all the computing elements to receive the brake control unit's preliminary report and process it along with additional data. The processor preferably is a dual processor with internal and external flash ROM, internal and external RAM, as well as accessing a dedicated non-volatile flash RAM 152 which stores the programming, data, constants, and other information needed to convert the raw sensor data or BCU report to the modified runway condition report. The runway condition monitoring unit 100 is powered by an aircraft on board battery 154 through a power filter 156 that also suppresses or eliminates transient power fluctuations and conducts power management through isolation and supply. The runway condition monitoring unit 100 also communicates directly with the BCU 210 through their respective communications interfaces 158 (e.g., the CANbus) to accept the BCU's preliminary runway condition report. The runway condition monitoring unit 100 is connected to the aircraft's data system with both a receiver 160 and transmitter 162 along the ARINC 429 data bus. Various discrete inputs such as weight on wheels, landing gear handles, ground spoiler, reverse thrust, etc. are received via a dedicated data port 164, and in situ dedicated sensors that evaluate GPS location, acceleration, or other parameters are connected at the data input port 166. The report generated by the processor can be sent along the universal serial bus 170 to the peripheral data bus and memory access 172, and there is a CAN bus data out port 174 used to communicate along a private data bus 176. The external fail data (status, fault codes, etc.) 180 for the discrete data outputs are passed along on a specialized data bus 178 if there is a communication failure for troubleshooting.

The runway condition monitoring system may process inputs from additional sensors, and each of the factors are analyzed to arrive at a braking quality factor of the runway condition. The various data buses such as CAN bus, ARINC429, IEEE1394, AFDX, and other available aircraft communications buses may be used with the current invention.

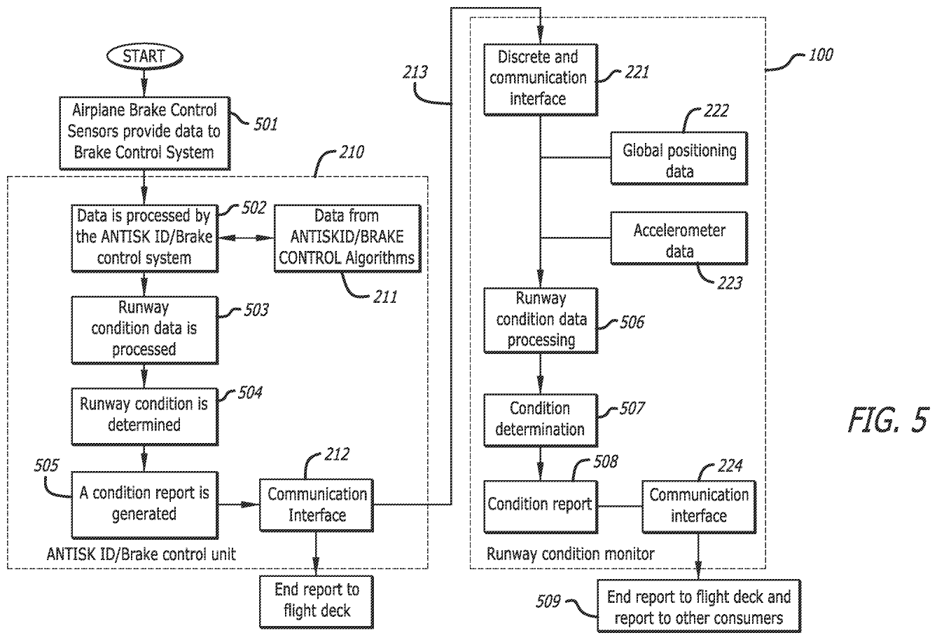

FIG. 5 corresponds to a flow chart for a method of developing and communicating a runway condition report and disseminating the report to various clients. The process starts by recording and processing airplane brake control data from sensors at the landing gear wheel and axle, such as those discussed with respect to FIG. 2. The data obtained by the various sensors are sent in step 501 to the brake control unit 210, which initially processes the information in step 502 using the anti-skid brake control system 211 in step 503 using stored algorithms in the BCU's processor. The processed data is then used to determine a preliminary runway condition in step 504 and generate a preliminary runway condition report in step 505. Using the communications system interface 212 within the BCU 210, the preliminary report is communicated via the aircraft data bus 213 to the communications system interface 221 of the runway condition monitoring unit 100. Additional data 222 from a GPS receiver and data 223 from an accelerometer associated with the runway condition monitoring unit is combined in step 506 with the preliminary report using the runway condition monitoring unit's processor using proprietary programming to modify or substantiate the preliminary runway condition report in step 507, and to create in step 508 the improved runway condition report utilizing the new data from the GPS and accelerometer. This new, improved runway condition report is sent to the runway condition monitoring unit's communication interface 224, which is configured to communicate directly with the flight deck and the air traffic control tower, as well as any other desired clients. The new report is forwarded in step 509 to one or both of these recipients, which in turn can use the information to pre-warn or educate pilots of subsequent flights on the status of the runways.

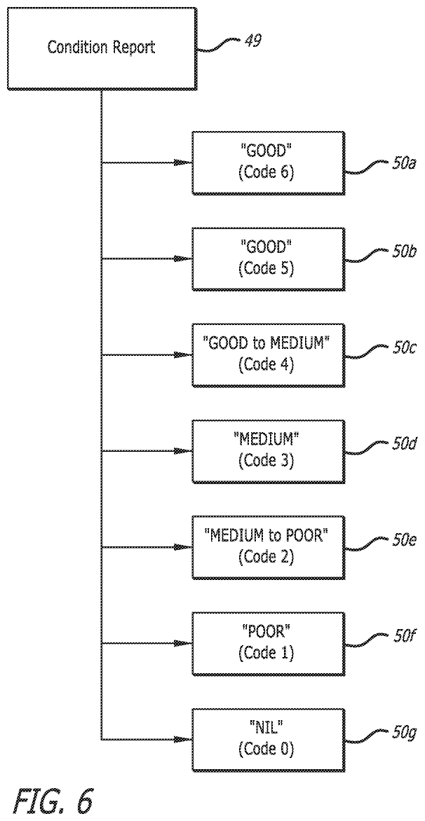

FIG. 6 is an exemplary runway condition report 50a-g that may be generated using qualitative measures for the current runway condition from the data or preliminary information 49 from the brake control unit 210. Note that other types of responses could also be used, including quantitative or some other form for evaluation. Here, conclusions fall within a 0-6 scale, where the highest value 6 corresponds to a “good” runway condition, and the lowest value 0 corresponds to a “nil” runway condition. Intermediate values correspond to “poor,” “medium to poor,” “medium,” “good to medium,” and “good.” Pilots can use this information to manage the braking system of subsequent flights and anticipate problems or dangerous conditions and take the necessary precautions to ensure a safe landing.

The report produced by the runway condition monitoring report may be an assessment of the entire landing from touchdown to a complete stop, or may focus solely on the conditions up to the predefined low speed threshold. Where GPS is incorporated, the report may specify specific locations on the runway if needed for additional clarity.

When the report is completed, it is transmitted to other clients such as an airline service center, air traffic control, or airport operations, where communication is through another onboard system or may be wireless through a telephone or satellite-based communication system. This automatic transmission saves the pilot from having to relay the report to ATC and ATC to other clients, and provides a more direct information flow to recipients and eliminates the potential for errors in verbal communications. One feature of the present invention is the inclusion of a USB interface that allows the runway condition monitoring unit to interface with peripheral devices and onboard internal memory access.

While various aspects and features of the present invention are disclosed herein, it is to be understood that the depictions and descriptions of the preferred embodiments should not be deemed to be limiting or exclusive of other variations. A person of ordinary skill in the art would readily recognize and appreciate many modifications, substitutions, and alterations to the preferred embodiments, and the scope of the invention properly includes all such modifications, substitutions, and alterations.

What is claimed:

1. An aircraft braking evaluation system to evaluate braking conditions on a runway, comprising:
a brake control unit that includes anti-skid control;
a dedicated accelerometer;
a dedicated GPS sensor;
a runway condition monitoring unit for determining an objective runway condition report based on data from the brake control unit, the processor configured to run a program having input from the brake control unit, the dedicated accelerometer, and the dedicated GPS sensor to generate an objective braking quality report for a specific runway; and
a communications system configured to transmit the objective braking quality report to a location remote to the aircraft.

2. The aircraft braking evaluation system of claim 1, wherein the runway condition monitoring unit utilizes GPS data to evaluate runway conditions at specific locations.

3. The aircraft braking evaluation system of claim 1, wherein the communications system links the aircraft braking evaluation system to an aircraft manufacturer.

4. The aircraft braking evaluation system of claim 1, further comprising a CANbus link between the brake control unit and the runway condition monitoring unit.

5. The aircraft braking evaluation system of claim 1, wherein the communications system links the aircraft braking evaluation system to an aircraft manufacturer.

6. The aircraft braking evaluation system of claim 1, further comprising a power filter and power transient suppression unit.

7. The aircraft braking evaluation system of claim 1, further comprising an ARINC 429 receiver.

8. The aircraft braking evaluation system of claim 1, wherein the runway condition monitoring unit is connected to the aircraft data bus.
